(19) United States
(12) Patent Application Publication
(10) Pub. No.: US 2006/0249536 A1
(43) Pub. Date: Nov. 9, 2006

(54) Device and method for dispensing a food product using a reclosable resilient valve

(76) Inventors: Eric E. Hartman, Ridgefield, CT (US); Bradley J. Feldman, Mohegan Lake, NY (US); Wendy S. Geiger, Norfolk, MA (US)

Correspondence Address: WINSTON & STRAWN LLP, 1700 K STREET, N.W., WASHINGTON, DC, 20006, US

(21) Appl. No.: 11/124,145

(22) Filed: May 9, 2005

(51) Int. Cl. B67D 5/56

(52) U.S. Cl. 222/129.3; 222/214

(57) ABSTRACT

The present invention relates to a food dispensing device for dispensing a food product. The device includes a valve/cannula connection assembly that provides a reclosable resilient sealed connection to a food container. A cannula is received in a resilient valve to open the valve.

### FIELD OF THE INVENTION

The present invention relates generally to a device for dispensing a food product. More particularly, the invention relates to a device and method for dispensing a food product from a container having a valve opened by a cannula interacting therewith.

### BACKGROUND OF THE INVENTION

Food products are often dispensed from countertop devices using “bag-in-box” packaging. These types of devices allow a used packaging to be exchanged for a new packaging when the food contents of the used packaging have been discharged. To exchange packagings, the user typically disconnects a connection member of a used packaging from the dispensing device, removes the used packaging from the device, and inserts and reconnects a new packaging in the device.

These types of countertop dispensing devices are commonly used in offices, convenience stores, and restaurants. In these settings, it is desirable that the devices preserve a high standard of hygiene for the food product, offer a clean and aesthetic interface for the user, and be relatively easy to operate and maintain. It is also desirable that the devices are able to dispense a variety of food product, having different consistencies and viscosities. Typical dispensing systems have been found to be lacking in one of these areas.

European Patent EP0998644 discloses a connector assembly that requires that an external male portion engage an internal female portion in a linear manner such that a bore of a female part is sealed off by a plug upon connection of the male and female portions. If the connecting motion is not linear or is out of alignment, this type of assembly often fails to seal completely, which can result in a catastrophic release of the food contents in the device. This connection assembly also does not provide a completely reclosable seal to keep the food product within the container upon repeated disconnections and cannot be used effectively to dispense food products that have an elevated viscosity.

PCT Publication No. WO2004/011361 discloses a dispensing device that uses a power or lever-operated actuator to engage a connection assembly. The actuator provides a force on the order of 25 lbs to securely fasten the connection assembly. This system is used for valves that require a linear and elevated force to operate, such as the type of connector assembly disclosed in EP0998644.

Thus, there is a need for a dispensing device that includes a connection assembly for connecting a food container to a dispensing device that is reliable, secure, and easy to operate, and is usable to dispense food products having a variety of consistencies and viscosities.

### SUMMARY OF THE INVENTION

A preferred embodiment of the device includes a food container, which defines a food space, and a fluid food product that is disposed within the food space. The device also includes a valve unit having a reclosable resilient valve that is associated with the food container and is in fluid communication with the food space. The valve is biased towards a closed position for sealing the food product within the food space and includes an openable portion.

The preferred embodiment also includes a cannula with a fluid conduit. The cannula is engageable with the valve for resiliently deforming the valve to an open position in which the openable portion defines a valve opening, communicated with the food space, to fluidly communicate the food space with the fluid conduit. Thus, food product can be received through the valve into the conduit. The cannula is preferably configured and dimensioned to be received within the valve opening in the open position. Additionally, the valve is preferably configured to seal about the cannula received within the valve opening.

Preferably, the valve defines a slit that is spread to define the valve opening in the open position. More preferably, the slit includes intersecting slits. In another embodiment, the valve can be a petuloid valve with petuloid portions that are resiliently bent by the cannula in the open position. The valve also includes a convex surface that is disposed adjacent the openable portion, facing the food space, and configured such that pressure from within the food space biases the valve to the closed position.

In the preferred embodiment, the fluid food product includes a slurry of solids and liquid such that deposits can form on the valve. The cannula is configured to positively open the valve with the food deposits thereon, and the valve is configured to return to the closed position upon disengagement from the cannula with food deposits present thereon to substantially prevent leakage.

The device also includes an at least semi-rigid container housing that houses the food container, and to which the valve unit is mounted. In the preferred embodiment, the food container preferably includes a plurality of food containers that are housed in the container housing, and the valve unit preferably includes a plurality of valve units that are substantially fixed or otherwise mounted to the container housing. The preferred device can also include a cannula support, and the cannula includes a plurality of cannulas mounted to the cannula support and disposed for aligning with the valve units to facilitate engagement of the cannulas with the valves.

In the preferred embodiment, the device includes an at least semi-rigid valve unit support and the valve unit preferably includes a plurality of valve units that are associated with the valve unit support at a predetermined spacing. The device can also have a cannula support and the cannula preferably includes a plurality of cannulas mounted to the cannula support in a configuration for aligning with the valve units at the predetermined spacing.

The device preferably includes a dispensing pump that is configured for dispensing the food product downstream of the fluid conduit. In one embodiment, the device is a beverage dispenser, and the food product includes a beverage or a beverage component. Preferably, the food product is a fluid concentrate. More preferably, the fluid concentrate includes a coffee concentrate, a chocolate concentrate, a syrup, a cocoa concentrate, a milk concentrate, a tea concentrate, a juice concentrate, or a combination thereof. The device can further include a mixer and a liquid supply that is associated with the fluid conduit for mixing the food product from the conduit with a liquid to prepare a food item.

A preferred method for dispensing a food product includes providing a food container that contains a food product in a food space, providing a valve unit that has a reclosable resilient valve to seal the food space, deforming the valve by moving a cannula against the valve to open a valve opening in the valve to fluidly communicate the food space with a fluid conduit in the cannula, and emptying the food product from the food container through the valve and fluid conduit. The method also includes mixing the food product from the fluid conduit with a liquid to prepare a food item, and then dispensing the food item for consumption. Preferably, the valve is deformed by inserting the cannula into the valve opening. Preferably, the food product includes a slurry of solids and liquid such that deposits form on the valve, and the method further includes positively opening the valve using the cannula despite the presence of the food deposits and returning the valve to the closed position with food deposits thereon upon disengagement of the valve from the cannula.

In one embodiment of the method, the valve unit includes a plurality of valve units and the cannula comprises a plurality of cannulas. The method further includes providing the plurality of valve units mounted to a valve unit support at a predetermined spacing from each other, providing a cannula support to which the cannulas are mounted in a configuration for aligning with the valve units on the valve unit support, and moving the valve unit support towards the cannula support to open the valves by moving the cannulas against the valves.

The present invention thus can enable a user to quickly and securely connect a food container to a dispensing device that is able to dispense a variety of food products, such as beverages, and is resistant to leaks caused by food deposits.

### BRIEF DESCRIPTION OF THE DRAWINGS

FIG. 1 is a front cut-away view of an embodiment of the valve units associated with the food containers and cannula units mounted to the cannula support;

FIG. 2 is a side cross-sectional view of the valve unit thereof;

FIG. 3 is a top view of the valve unit;

FIG. 4 is a top view of another embodiment of a petuloid valve;

FIG. 5 is a front cross-sectional view of an embodiment of the cannula unit;

FIG. 6 is a front perspective view thereof;

FIG. 7 is a front cross-sectional view of the embodiment of the valve/cannula assembly; and

FIG. 8 is a schematic view of an embodiment of the dispensing device.

### DETAILED DESCRIPTION OF THE PREFERRED EMBODIMENTS

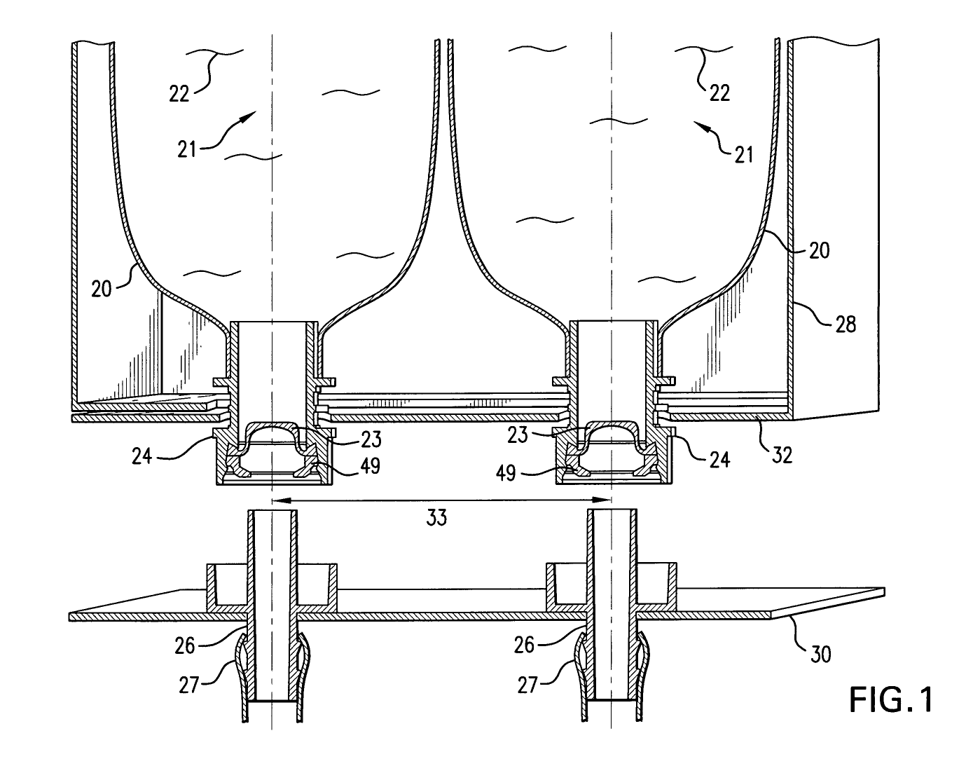

Referring to FIG. 1, a preferred embodiment of the food dispensing device includes at least one food container 20, and preferably two. The food containers 20 contain food products 22 within food spaces 21. The preferred dispensing device is a beverage dispenser, and one or both of the food products 22 are preferably beverages or beverage components. A “beverage” is herein understood to mean any beverage, hot or cold, that can be prepared from at least one concentrate, such as a syrup, a coffee concentrate, a cocoa concentrate, a milk concentrate, a juice concentrate, a tea concentrate or a combination thereof. The concentrate is preferably mixed with a liquid, such as water, to produce a beverage suitable for consumption, such as a soft drink, a coffee drink, a tea drink, a juice, or a milk-based drink. Preferably, the beverages or beverage components include fluid concentrates. In one embodiment, a coffee fluid-concentrate is used, which can include, for example, coffee solids, coffee aroma, and/or a whitener or dairy product.

The food container 20 is preferably of a bag-in-box type, although the dispensing device can use other types of food containers generally known in the art. The food container 20 is preferably housed within an at least semi-rigid container housing 28, which is configured to allow for easy “drop and load” insertion of the container housing 28 and associated food container 20 in the interior of the dispensing device housing 10. Preferably, the container housing 28 includes a cardboard or plastic material that is folded on the bottom such that the bottom of the housing 28 includes two layers. In the preferred embodiment, the housing 28 contains two food containers 20, each having a different food product 22. Additionally, there are openings in at least one of the bottom layers of the housing 28 configured for mounting a valve unit 24 of each food container 20.

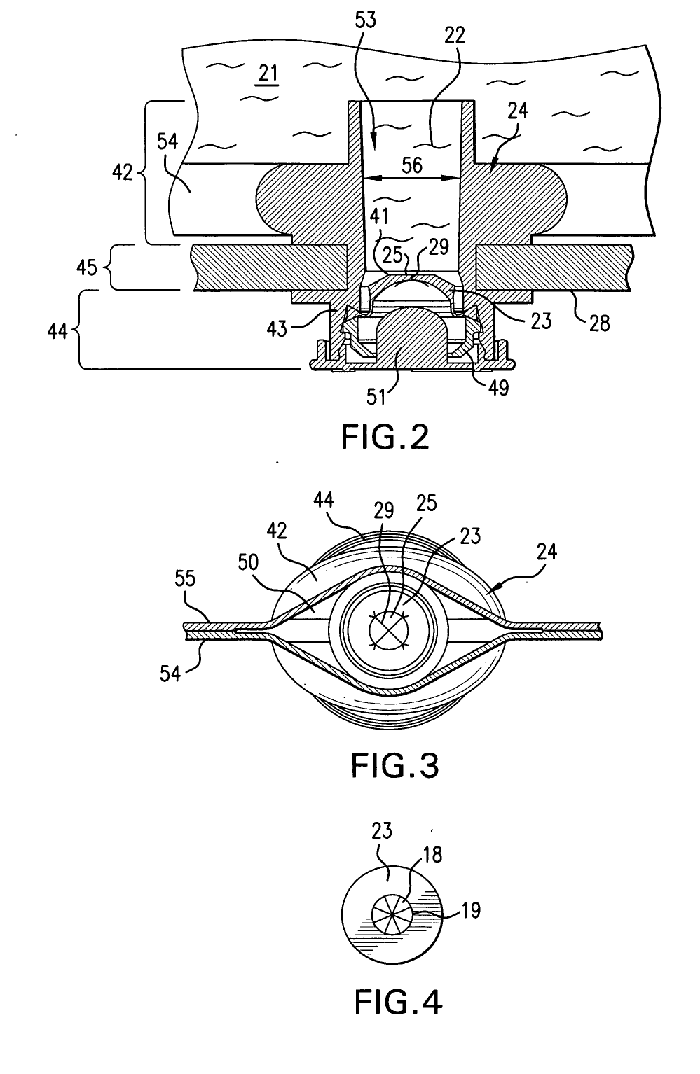

Referring to FIGS. 1 and 2, the valve units 24 are disposed at the bottom of each food container 20. The valve unit 24 is in fluid communication with the food space 21 and the food product 22 therein. Each valve unit 24 has a reclosable resilient valve 23 that includes an openable portion 25. The openable portion 25, when in an open position, allows food product 22 to pass therethrough. The valve 23 also preferably has a convex surface 41 disposed adjacent the openable portion 25 and facing the food space 21, which is normally and preferably naturally biased towards a closed position for sealing the food product 22 within the food space 21.

In the preferred embodiment, the valve unit 24 of each food container 20 is also associated with a valve unit support 32, as shown in FIG. 1. The valve unit support 32 can include the bottom panel of the container housing 28, or it can be a separate member associated with and adjacent to the bottom panel or otherwise connected to the container housing 28. Preferably, the valve unit support 32 is made of an at least a semi-rigid material. The valve units 24 are preferably associated with the valve unit support 32 at a predetermined spacing 33, such that they are positioned and aligned for engagement with cannula units 26 when a cannula support 30 is moved towards the container housing 28. The predetermined spacing 33 is preferably dependent on the volume of the food containers 20 and the space required between the valve units 24 when the food containers 20 are disposed next to each other in the container housing 28. Preferably, the predetermined spacing 33 is between about 30 mm and about 100 mm. More preferably, the predetermined spacing 33 is between about 50 mm and about 70 mm, and in one embodiment is about 60 mm.

Each valve unit 24 includes an upper portion 42 configured to be attached to and disposed within part of the food container 20, extending to the food space 21. The lower portion 44 of the valve unit 24 protrudes out of the food container 20 and the container housing 28 and is configured for engagement with a cannula. Preferably, the lower portion 44 includes an extended well 43 for receiving a cannula therein. The lower portion 44 also includes an entry member 49 configured for controlling the amount of pressure necessary to open the valve 23.

Advantageously, a cap 51 can be fitted over the extended well 43 when the valve unit 24 is not engaged by the cannula unit 26 or when the food container 20 is being stored or transported to prevent contamination of the food product 22 or leakage of the food product 22 within the dispensing device. The valve unit 24 also includes a middle portion 45 between the upper portion 42 and the lower portion 44, which allows for easy handling of the valve unit 24 during manufacturing. The middle portion 45 is also configured for receiving a valve unit support 32 and/or the container housing 28 to which the valve unit 24 can be mounted. A channel 53 extends through the valve unit 24 from the upper portion 42 to the lower portion 44 and includes openings at both ends to allow the food product 22 to pass therethrough. The channel 53 preferably has a diameter 56 sufficient to receive a cannula therein. Preferably, the channel 53 has a diameter 56 between about 1 mm and 25 mm, and more preferably, the diameter 56 is between about 10 mm and 15 mm. The diameter 56 of the channel 53 is also dependent on the viscosity of the food products 22 and the desired flow rates thereof to be passed therethrough.

Referring to FIG. 3, the preferred embodiment of the valve unit 24 is configured as a fitment for the food container 20, preferably as a “boat fitment”. The valve unit 24 has an extended portion 50 that extends radially from the valve 23 and is configured to provide a smooth transition and association between the side walls 54,55 of the food container 20 and the valve unit 24 as the side walls seal thereto, as shown in FIGS. 2 and 3. In this manner, the valve unit 24 is advantageously sealed into the bottom of the food container 20, with the side walls 54,55 of the food container 20 wrapping around the taper of the extended portion 50.

Preferably, the resilient valve 23 is made of a resilient thermoplastic elastomer including, for example, silicone. The openable portion 25 of the valve 23 is configured for allowing a cannula to penetrate therethrough. Preferably, the valve 23 includes a slit 29 that opens to define a valve opening in the open position. The slit 29 can also include intersecting slits that define the valve opening. As shown in FIG. 4, the valve 23 can also include a petuloid valve 19 with petuloid portions 18 that are resiliently bent in the open position upon penetration by a cannula.

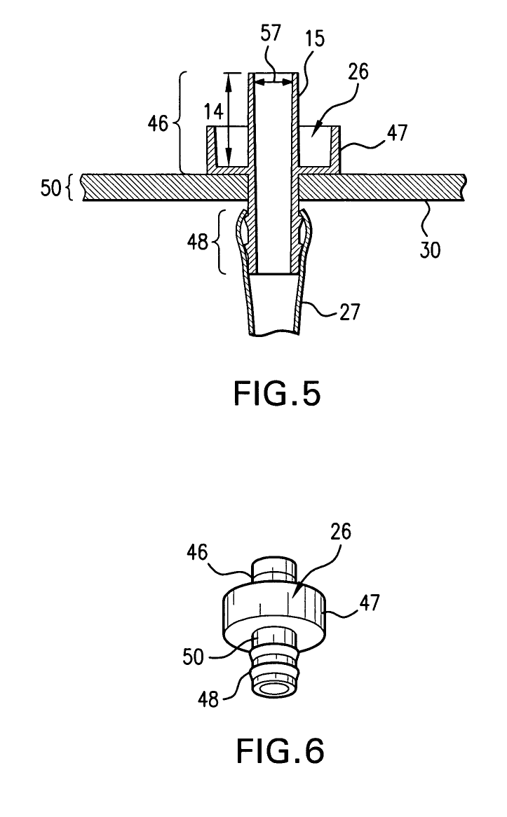

Referring to FIGS. 5, 6 and 7, the dispensing device also includes at least one cannula unit 26 that has a fluid conduit 27. The cannula unit 26 is configured for engagement with the valve unit 24 for resiliently deforming the valve 23 to an open position. In the open position, the openable portion 25 defines a valve opening for the food space 21 to communicate with the fluid conduit 27 for receiving the food product 22 therethrough. In the preferred embodiment, the device includes two cannula units 26 for engaging the two valve units 24 of the two food containers 20.

The cannula unit 26 includes an upper portion 46 configured for engaging with the lower portion 44 of the valve unit 24. The upper portion 46 includes a cannula portion 15 that has an annular construction and is configured for extending to penetrate the resilient valve 23 of the valve unit 24. Preferably, the cannula portion 15 has a length 14 sufficient to allow the cannula portion 15 to penetrate the valve 23 when the cannula unit 26 engages the valve unit 24. Preferably, the length 14 is such that when the cannula portion 15 is fully inserted in the valve 23, the cannula portion 15 substantially clears the slits and/or petuloid portions of the valve 23 in the open position to ensure that these members do not block the flow of food products 22 through the cannula portion 15. In another embodiment, the cannula portion 15 does not completely clear the valve 23, but deforms the valve sufficiently to substantially prevent the valve 23 from blocking the outflow of food products 22.

The interior of the cannula portion 15 has a cross-sectional shape, preferably with a diameter 57 selected depending on the viscosity of the food products 22 and the desired flow rates thereof to be passed therethrough. Advantageously, one of the cannula portions 15 can have a different diameter 57 than another cannula portion, such as when using food products 22 of different viscosities or flowing at different rates. Cannula portions 15 of different sizes can also be used with substantially the same size valve 23. Additionally, the upper portion 46 includes an extended well 47 that is configured to receive the extended well 43 of valve unit 24. The cannula unit 26 also includes a lower portion 48 configured for receiving the fluid conduit 27. Disposed between the upper portion 46 and lower portion 48 of the cannula unit 26 is a middle portion 50 configured for attachment to a cannula support 30 to mount the cannula unit 26 thereto.

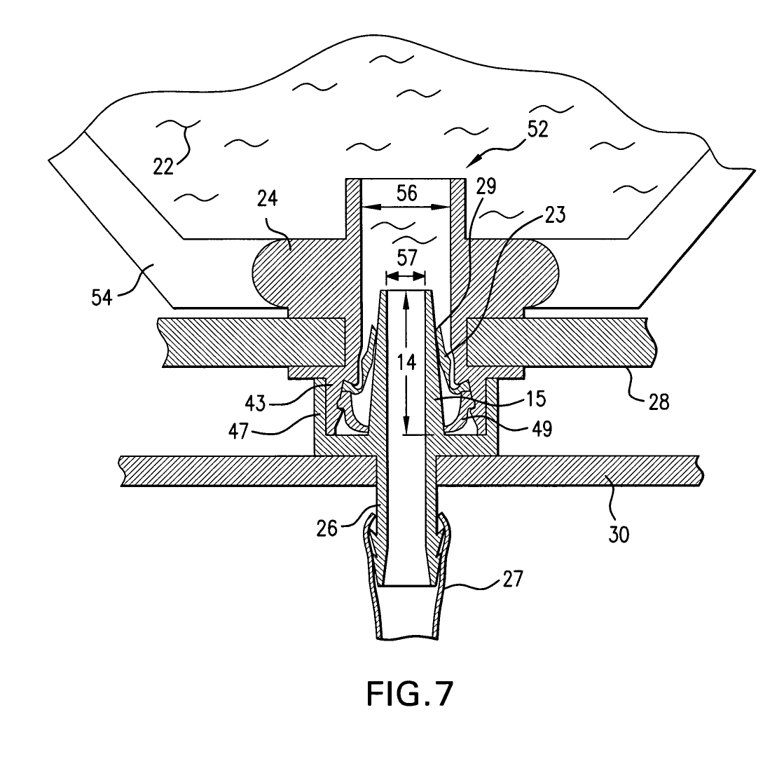

In the preferred embodiment, the cannula units 26 are mounted to a cannula support 30 as shown in FIGS. 1 and 7. Preferably, the cannula units 26 are configured for aligning the cannula portions 15 with the valve units 24 to facilitate engagement with the valve units 24 and the resilient valves 23. Preferably, the cannula units 26 are mounted to the cannula support 30 at the predetermined spacing 33. In the preferred embodiment, the container housing 28 is brought towards and disposed on top of the cannula support 30. Advantageously, only a minimal amount of force is required in order to sufficiently facilitate engagement between the cannula units 26 and the valve units 24. A mechanical or power-assisted means is preferably not required to achieve engagement. Preferably, less than about 3 lbs of force is required to facilitate engagement between the cannula units 26 and the valve units 24. More preferably, only between about 1.2 lbs and about 1.5 lbs of force is required for engagement. Most preferably, the weight of the container housing 28 with the food containers 20 therein, provides a force sufficient to engage the cannula units 26 and the valve units 24.

Referring to FIG. 7, the valve unit 24 and cannula unit 26 can preferably be engaged to form a valve/cannula assembly 52 that sealingly connects the food container 20 in the dispensing device. The cannula portion 15 is configured and dimensioned to be received within the valve opening of the valve 23 in the open position. When the cannula portion 15 penetrates the valve opening, the valve 23 is preferably configured to advantageously seal about the cannula portion 15 received within the valve opening. The seal provided by the valve/cannula assembly 52 advantageously reduces and minimizes the risk that food product 22 will leak from the food container 20 into the dispensing device, which can result in the unsanitary appearance of the device or lead to further contamination of the remaining food product 22 in the container 20. Additionally, the reclosable seal avoids frequent or intense cleaning of the dispensing device and reduces the risk that the food product will spoil due to exposure to the ambient air.

The relationship between the diameter 57 of the cannula portion 15 to the length of the slit 29 is useful in providing the benefits of a reclosable, sealed connection of the valve 23. In the preferred embodiment, the slits 29 are slightly longer than the diameter 57 of the cannula portion 15. Preferably, the ratio of length of the slit 29 to the diameter 57 of the cannula portion 15 is less than about 2 to 1. More preferably, the ratio is between about 1.5 to 1, and even more preferably between 1.25 to 1. Most preferably, the ratio of length of the slit 29 to the diameter 57 is greater than 1.

Advantageously, the valve 23 is reclosable and provides a resilient, sealed connection with the cannula portion 15 even upon connecting and disconnecting the food container 20 from the dispensing device multiple times, preferably at least about 10 times reliably. This feature allows the food container 20 to be removed from the dispensing device, for example, when it is desired to clean the device or to store the food container 20 in a refrigerator, and still maintain a sealed connection between the food container 20 and the dispensing device upon reconnection. As a result of the reclosable sealed connection, the valve 23 also reduces or eliminates the amount of food product 22 that dries or cakes on the valve/cannula assembly 52 as is typically seen after use in other dispensers. Compared to previous dispensers, the valve/cannula assembly 52 also allows for a greater degree of misalignment and misorientation between the valve unit 24 and cannula unit 26 while still maintaining the reclosable seal of the valve 23.

Another advantage of the valve/cannula assembly 52 is that the food product 22 that is dispensed can include a slurry of solids and liquid. Specifically, the valve/cannula assembly 52 allows the device to dispense food product 22 having a viscosity of about 1 cp to about 5000 cp. Preferably, the food product 22 has a viscosity of about 200 cp to about 3000 cp, and more preferably, food product 22 has a viscosity of about 500 cp to about 2200 cp. Even if solid deposits of the food product 22 form on the valve 23, the cannula portion 15 can positively open the valve 23 despite the presence of the food deposits thereon and the valve 23 can return to the closed position when the cannula portion 15 is disengaged to sufficiently seal the food container 20. Advantageously, this feature allows the dispensing device to dispense a wider variety of food product 22, even those having a higher viscosities.

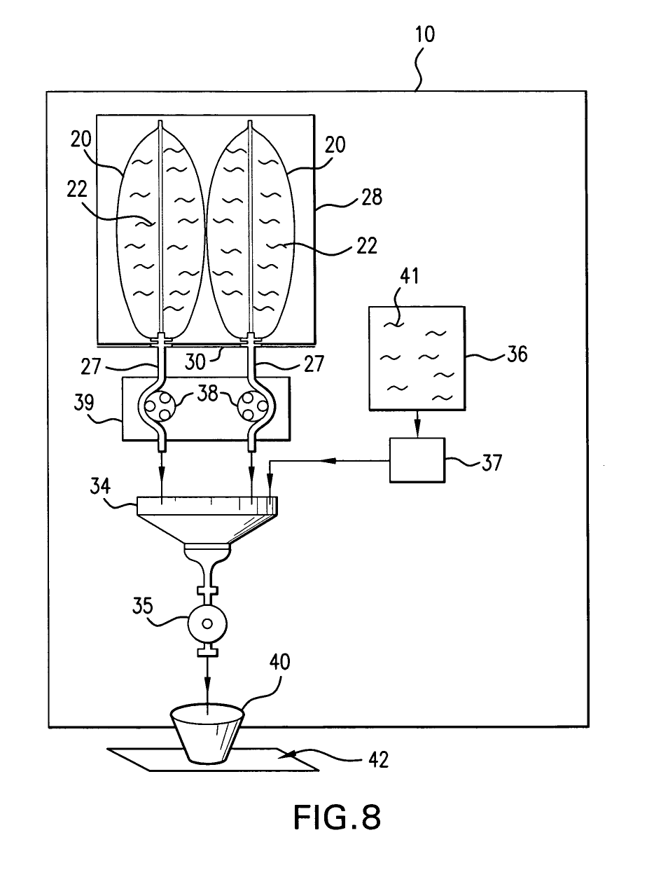

Referring to FIG. 8, a preferred embodiment of the dispensing device is a beverage dispenser that includes a dispensing device housing 10 and the container housing 28 within which is housed the food containers 20 that contains beverage components 22. A dispensing mechanism 38 is configured for dispensing the beverage components 22 downstream of the fluid conduits 27. Preferably, the dispensing mechanism 39 includes a pump 38 for each conduit 27 to pump the fluid therefrom. More preferably, the pumps 38 are peristaltic pumps, although other suitable pumps can be used. The dispensing mechanism 39 preferably dispenses the beverage components to a mixer 34.

The dispensing device also includes a liquid supply 36 that can be associated with a pump 37 if needed. Preferably the liquid supply supplies water 41 or another liquid to dilute or mix the beverage components. The water 41 from the liquid supply 36 is preferably dispensed into the mixer 34 for mixing with the beverage components to prepare a beverage. The beverage is then be dispensed from the mixer 34, optionally passing through a whipper 35, and then is dispensed into a serving container 40 received at a serving location 42. In one embodiment, a heating or refrigeration element is provided to heat or cool the mix of beverage components and liquid supply or mixture thereof before dispensing.

The term “about,” as used herein, should generally be understood to refer to both numbers in a range of numerals. Moreover, all numerical ranges herein should be understood to include each whole integer with the range.

While illustrative embodiments of the invention are disclosed herein, it will be appreciated that numerous modifications and other embodiments can be devised by those skilled in the art. Features of the embodiments described herein can be combined, separated, interchanged, and/or rearranged to generate other embodiments. Therefore, it will be understood that the appended claims are intended to cover all such modifications and embodiments that come within the spirit and scope of the present invention.

What is claimed is:

1. A food dispensing device, comprising:
a food container defining a food space;
a fluid food product disposed within the food space;
a valve unit comprising a reclosable resilient valve associated with the food container and in fluid communication with the food space, the valve being resiliently biased towards a closed position for sealing the food product within the food space and comprising an openable portion; and
a cannula comprising a fluid conduit and being engageable with the valve unit for resiliently deforming the valve to an open position in which the openable portion defines a valve opening to the food space to fluidly communicate the food space with the fluid conduit for receiving the food product therethrough.

2. The device of claim 1, wherein the valve defines a slit that is spread to define the valve opening in the open position.

3. The device of claim 2, wherein the slit comprises intersecting slits.

4. The device of claim 1, wherein the valve comprises a petuloid valve with petuloid portions that are resiliently bent by the cannula in the open position.

5. The device of claim 1, wherein the valve has a convex surface disposed adjacent the openable portion facing the food space, and configured such that pressure from within the food space biases the valve to the closed position.

6. The device of claim 1, wherein the fluid food product comprises a slurry of solids and liquid such that deposits can form on the valve, the cannula is configured to positively open the valve with deposits formed thereon, and the valve is configured to return to the closed position upon disengagement from the cannula with food deposits present thereon to substantially prevent leakage.

7. The device of claim 1, further comprising an at least semi-rigid container housing that houses the food container, wherein the valve unit is mounted to the container housing.

8. The device of claim 7, wherein:
the food container comprises a plurality of food containers housed in the housing;
the valve unit comprises a plurality of valve units that are mounted to the container housing;
the dispensing device further comprises a cannula support; and
the cannula comprises a plurality of cannulas mounted to the cannula support and disposed for aligning with the valve units to facilitate engagement therewith.

9. The device of claim 1, further comprising a valve unit support that is at least semi-rigid and supports the valve units.

10. The device of claim 1, wherein the dispensing device is a beverage dispenser, and the food product is a beverage or beverage component.

11. The device of claim 10, further comprising a dispensing pump configured for dispensing the food product downstream of the fluid conduit.

12. The device of claim 10, wherein the food product comprises a fluid concentrate.

13. The device of claim 12, wherein the fluid concentrate comprises a coffee concentrate, a chocolate concentrate, a syrup, a cocoa concentrate, a milk concentrate, a tea concentrate, a juice concentrate, or a combination thereof.

14. The device of claim 10, further comprising a mixer and a liquid supply associated with the fluid conduit for mixing the food product from the conduit with a liquid to prepare a food product.

15. The device of claim 1, wherein the cannula is configured and dimensioned to be received within the valve opening in the open position.

16. The device of claim 15, wherein the valve is configured to seal about the cannula received within the valve opening.

17. A method for dispensing a food product, comprising:
providing a food container that contains a food product in a food space;
providing a valve unit comprising a reclosable resilient valve to seal the food space;
deforming the valve by moving a cannula thereagainst to open a valve opening in the valve to fluidly communicate the food space with a fluid conduit; and
emptying the food product from the food container through the valve and fluid conduit.

18. The method of claim 17, further comprising:
mixing the food product from the fluid conduit with a liquid to prepare a food item; and
dispensing the food item for consumption.

19. The method of claim 17, wherein the valve is deformed by inserting the cannula into the valve opening.

20. The method of claim 17, wherein the food product comprises a slurry of solids and liquid such that deposits can form on the valve, the method further comprising positively opening the valve using the cannula despite the presence of the food deposits and returning the valve to the closed position with food deposits thereon upon disengagement of the valve from the cannula.

21. The method of claim 17, wherein the valve unit comprises a plurality of valve units and the cannula comprises a plurality of cannulas, the method further comprising:
providing the plurality of valve units mounted to a valve support at a predetermined spacing from each other;
providing a cannula support to which the plurality of cannulas are mounted in a configuration for aligning with the valve units on the valve support; and
moving the valve support towards the cannula support to open the valves by moving the cannulas thereagainst.
